(19) United States
(12) Patent Application Publication
(10) Pub. No.: US 2019/0075812 A1
(43) Pub. Date: Mar. 14, 2019

(54) ELECTROMAGNETICALLY CONTROLLED BLADE GUIDED PERMEATION TEA FIXATION CONTROL SYSTEM

(71) Applicant: Wai Hung YEUNG, Hong Kong (HK)

(72) Inventor: Wai Hung YEUNG, Hong Kong (HK)

(21) Appl. No.: 15/721,826

(22) Filed: Sep. 30, 2017

(30) Foreign Application Priority Data
Sep. 8, 2017 (CN) 201710806500.8

(51) Int. Cl. A23F 3/06

(52) U.S. Cl. CPC A23F 3/06; B65G 17/12

(57) ABSTRACT

The present invention relates to an electromagnetically controlled blade guided permeation tea fixation control system, comprises a machine frame, a conveying device, a fixation drum, a guiding device, a cooling device, a heating control device and a dehumidifying device, an entrance and an exit are disposed at the two ends of the fixation drum; a pair of semicircular drum stands are disposed at the two sides of the machine frame for mounting the fixation drum thereon; a ring shaped slide rail is disposed along the outer edge of the fixation drum that corresponds to the semicircular drum stands, an outer ring gear is disposed at a center part of the outer edge of the fixation drum; a motor is disposed at a bottom of the machine frame, driving teeth are disposed on the main shaft of the motor for meshing with the outer ring gear. The system of the present invention has a reasonable structure, can control tea fixation time while the fixation drum is rolling, possesses a high work efficiency.

### FIELD OF INVENTION

The present invention relates to the field of tea fixation equipment, in particular to an electromagnetically controlled blade guided permeation tea fixation control system.

### BACKGROUND OF INVENTION

Tea fixation is a step in tea processing by destruction and deactivation of oxidation enzymes of fresh tea leaves, inhibiting enzymatic oxidation of tea polyphenols in fresh leaves, partially evaporating water in the leaves, softening the leaves for easy rolling into shape, and removing green smell and promoting aroma at the same time. Rolling fixation machines can perform functions such as fixing and tumbling etc. Traditionally the structure comprises a machine frame, a conveying mechanism, a rolling drum and an input at the left side, a heating device below the rolling drum, hot air box, blower, and pipe at the top of the rolling drum. Its characteristic is: having a hot air box at a back of the rolling drum, air in the hot air box absorbs the heat generated by the heating device, air blower blows into the hot air box, hot air flows from the tea entrance into the rolling drum. A leaf blower is installed at the exit to cool down tea leaves after fixation. Traditional fixation drums is hard to load, hard to control the heat level of fixation, therefore fixation quality is low.

### SUMMARY OF INVENTION

The technical problem to be solved by the present invention is: to overcome the aforementioned problem, an electromagnetically controlled blade guided permeation tea fixation control system is provided. The system has a reasonable structure, can control tea fixation time while the fixation drum is rolling, possesses a high work efficiency.

The technical solution used in the present invention to solve the technical problem is: an electromagnetically controlled blade guided permeation tea fixation control system, comprises a machine frame, a conveying device, a fixation drum, a guiding device, a cooling device, a heating control device and a dehumidifying device, an entrance and an exit are disposed at the two ends of the fixation drum; a pair of semicircular drum stands are disposed at the two sides of the machine frame for mounting the fixation drum thereon; a ring shaped slide rail is disposed along the outer edge of the fixation drum that corresponds to the semicircular drum stands, an outer ring gear is disposed at a center part of the outer edge of the fixation drum; a motor is disposed at a bottom of the machine frame, driving teeth are disposed on the main shaft of the motor for meshing with the outer ring gear; a recessed chamber is disposed at an inside of the semicircular drum stand, a number of rollers are uniformly distributed inside the recessed chamber; the rollers are disposed inside the recessed chamber through a roller shaft.

The guiding device comprises a number of rows of spiral guiding blades parallelly disposed inside the fixation drum, a rotator shaft disposed inside the interior wall of the fixation drum for mounting the spiral guiding blades, a pinion drivably connected to the rotator shaft and a drive guiding device; the drive guiding device comprises a number of racks drivably connected to the pinion, a guide stand disposed at an exterior ring of the fixation drum and fixed to an end of the rack; a limiter chamber is disposed at a side wall of the fixation drum for mounting the guide stand; a permanent magnet is disposed at a bottom end of the guide stand, an electromagnet is disposed inside the limiter chamber for controlling a displacement of the permanent magnet.

The heating control device comprises an infrared electric heater plate disposed an in inside layer of the fixation drum, a number of temperature and humidity sensors disposed at an inner wall of the fixation drum and an operation control computer disposed beside the machine frame; an arced transparent glass is disposed at an upper part of the infrared electric heater plate; the arced transparent glass is aligned with the inner wall of the fixation drum; a number of slide preventing groove is disposed on the arced transparent glass.

The dehumidifying device comprises a flow pipe groove transversely disposed at a side wall of the fixation drum, a water permeable board fitted inside the flow pipe groove and a number of drainage holes disposed at a bottom of the flow pipe groove; slant openings are disposed at an upper part of the flow pipe groove.

In a preferred embodiment, the conveying device comprises a first conveyor disposed at a front end of the entrance and a second conveyor disposed at a back end of the exit.

In a preferred embodiment, the cooling device comprises a channel box inserted into a back end of the second conveyor, a cooler compressor disposed at an upper part of the channel box, a cold air mouth is disposed inside the channel box.

In a preferred embodiment, the infrared electric heater plate, the temperature and humidity sensors, the motor, the conveying device, the electromagnet and the cooler device are electrically connected to the operation control computer.

In a preferred embodiment, the water permeable board is made of permeable ceramics.

The advantage of the present invention is: the electromagnetically controlled blade guided permeation tea fixation control system of the present invention has a reasonable structure, the fixation drum has a number of rows of spiral guide blades that can be adjusted through the direction of rotation of the rotator shaft, the drive guiding device has racks for driving the rotator shaft, controlling the displacement of the racks by the electromagnet, thus adjusting the direction of the spiral guide blades, controlling flow of tea leaves and fixation time inside the fixation drum; the fixation drum has a dehumidifying device at its side wall, removing water from drainage holes through the water permeable board, possesses a high work efficiency.

### BRIEF DESCRIPTION OF DRAWINGS

The present invention is further explained below with the accompanying drawings and embodiments.

FIG. 1 is an overall structural schematic diagram of an electromagnetically controlled blade guided permeation tea fixation control system according to the present invention.

FIG. 2 is a structural schematic diagram of a semicircular rolling drum of an electromagnetically controlled blade guided permeation tea fixation control system of the present invention.

FIG. 3 is a structural schematic diagram of a heating control device of an electromagnetically controlled blade guided permeation tea fixation control system of the present invention.

FIG. 4 is a structural schematic diagram of a guiding device of an electromagnetically controlled blade guided permeation tea fixation control system of the present invention.

FIG. 5 is a structural schematic diagram of a dehumidifying device of an electromagnetically controlled blade guided permeation tea fixation control system of the present invention.

Reference numbers in the drawings: 1 machine frame, 11 semicircular drum stand, 111 recessed chamber, 112 roller, 113 roller shaft, 12 motor, 2 fixation drum, 21 entrance, 22 exit, 23 ring shaped slide rail, 24 outer ring gear, 25 limiter chamber, 251 electromagnet, 3 first conveyer, 31 second conveyer, 4 infrared electric heater plate, 41 operation control computer, 42 arced transparent glass, 43 slide preventing groove, 5 channel box, 51 cooler compressor, 7 spiral guide blades, 71 rotator shaft, 72 pinion, 73 rack, 74 guide stand, 741 permanent magnet, 8 flow pipe groove, 81 water permeable board, 82 drainage hole, 83 slant opening.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

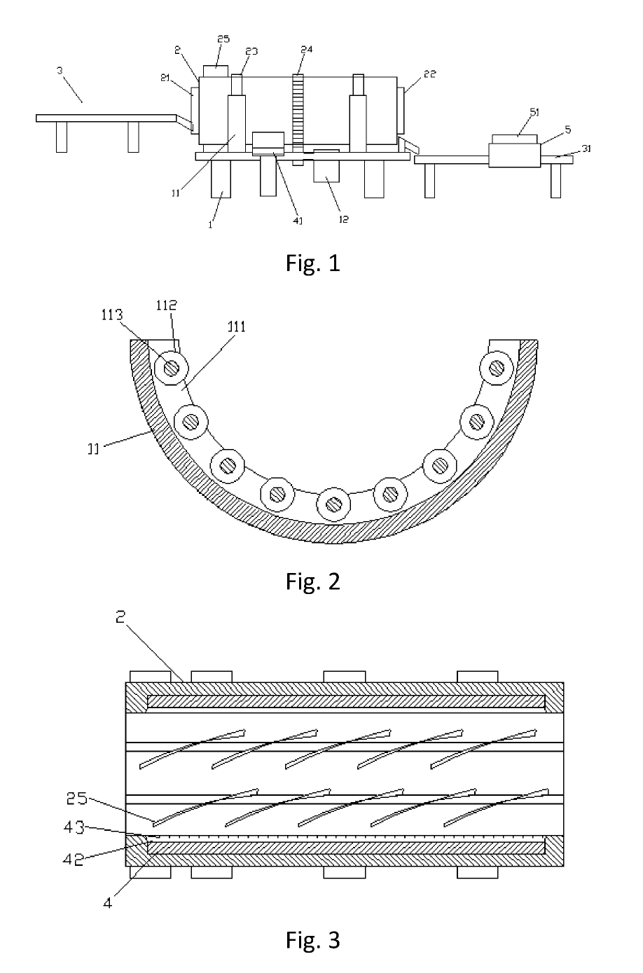

An electromagnetically controlled blade guided permeation tea fixation control system is shown in FIGS. 1 and 2. The fixation control system comprises a machine frame 1, a conveying device, a fixation drum 2, a guiding device, a cooling device, a heating control device and a dehumidifying device, an entrance 21 and an exit 22 are disposed at the two ends of the fixation drum 2; a pair of semicircular drum stands 11 are disposed at the two sides of the machine frame 1 for mounting the fixation drum 2 thereon; a ring shaped slide rail 23 is disposed along the outer edge of the fixation drum 2 that corresponds to the semicircular drum stands 11, an outer ring gear 24 is disposed at a center part of the outer edge of the fixation drum 2; a motor 12 is disposed at a bottom of the machine frame, driving teeth are disposed on the main shaft of the motor 12 for meshing with the outer ring gear 24; a recessed chamber 111 is disposed at an inside of the semicircular drum stand 11, a number of rollers 112 are uniformly distributed inside the recessed chamber 111; the rollers 112 are disposed inside the recessed chamber 111 through a roller shaft 113; the conveying device comprises a first conveyor 3 disposed at a front end of the entrance 21 and a second conveyor 31 disposed at a back end of the exit 22.

The cooling device comprises a channel box 5 inserted into a back end of the second conveyor 31, a cooler compressor 51 disposed at an upper part of the channel box 5, a cold air mouth is disposed inside the channel box 5.

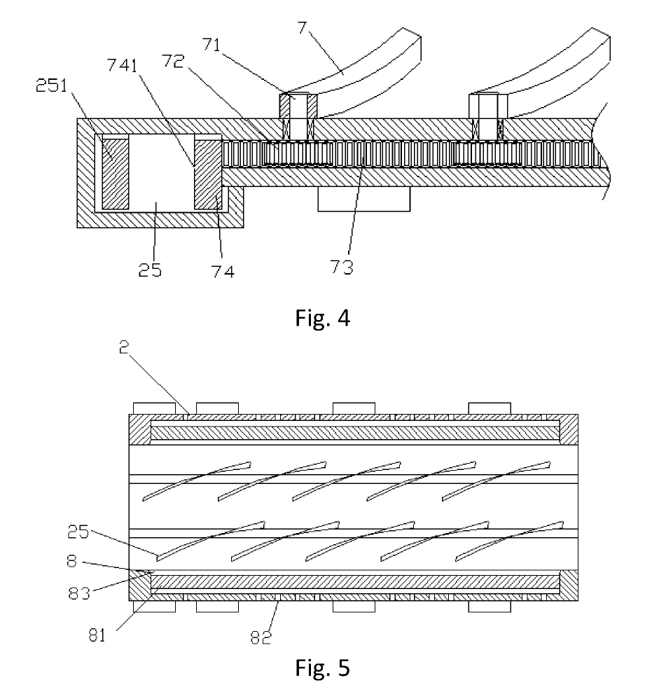

In an electromagnetically controlled blade guided permeation tea fixation control system as shown in FIG. 4, the guiding device comprises a number of rows of spiral guiding blades 7 parallelly disposed inside the fixation drum 2, a rotator shaft 71 disposed inside the interior wall of the fixation drum 2 for mounting the spiral guiding blades 7, a pinion 72 drivably connected to the rotator shaft 71 and a drive guiding device; the drive guiding device comprises a number of racks 73 drivably connected to the pinion 72, a guide stand 74 disposed at an exterior ring of the fixation drum 2 and fixed to an end of the rack 73; a limiter chamber 25 is disposed at a side wall of the fixation drum 2 for mounting the guide stand 74; a permanent magnet 741 is disposed at a bottom end of the guide stand 74, an electromagnet 251 is disposed inside the limiter chamber 25 for controlling a displacement of the permanent magnet 741.

In an electromagnetically controlled blade guided permeation tea fixation control system as shown in FIG. 3, the heating control device comprises an infrared electric heater plate 4 disposed an in inside layer of the fixation drum 2, a number of temperature and humidity sensors disposed at an inner wall of the fixation drum 2 and an operation control computer 41 disposed beside the machine frame 1; an arced transparent glass 42 is disposed at an upper part of the infrared electric heater plate 4; the arced transparent glass 42 is aligned with the inner wall of the fixation drum 2; a number of slide preventing groove 43 is disposed on the arced transparent glass 42;

In an electromagnetically controlled blade guided permeation tea fixation control system as shown in FIG. 5, the dehumidifying device comprises a flow pipe groove 8 transversely disposed at a side wall of the fixation drum 2, a water permeable board 81 fitted inside the flow pipe groove 8 and a number of drainage holes 82 disposed at a bottom of the flow pipe groove 8; slant openings 83 are disposed at an upper part of the flow pipe groove 8.

The infrared electric heater plate 4, the temperature and humidity sensors, the motor 12, the conveying device, the electromagnet 251 and the cooler device are electrically connected to the operation control computer 41. The water permeable board 81 is made of permeable ceramics.

The electromagnetically controlled blade guided permeation tea fixation control system of the present invention has a reasonable structure, the fixation drum has a number of rows of spiral guide blades that can be adjusted through the direction of rotation of the rotator shaft, the drive guiding device has racks for driving the rotator shaft, controlling the displacement of the racks by the electromagnet, thus adjusting the direction of the spiral guide blades, controlling flow of tea leaves and fixation time inside the fixation drum; the fixation drum has a dehumidifying device at its side wall, removing water from drainage holes through the water permeable board, possesses a high work efficiency.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. An electromagnetically controlled blade guided permeation tea fixation control system, comprises a machine frame, a conveying device, a fixation drum, a guiding device, a cooling device, a heating control device and a dehumidifying device, an entrance and an exit are disposed at the two ends of the fixation drum; a pair of semicircular drum stands are disposed at the two sides of the machine frame for mounting the fixation drum thereon; a ring shaped slide rail is disposed along the outer edge of the fixation drum that corresponds to the semicircular drum stands, an outer ring gear is disposed at a center part of the outer edge of the fixation drum; a motor is disposed at a bottom of the machine frame, driving teeth are disposed on the main shaft of the motor for meshing with the outer ring gear; a recessed chamber is disposed at an inside of the semicircular drum stand, a number of rollers are uniformly distributed inside the recessed chamber; the rollers are disposed inside the recessed chamber through a roller shaft;
the guiding device comprises a number of rows of spiral guiding blades parallelly disposed inside the fixation drum, a rotator shaft disposed inside the interior wall of the fixation drum for mounting the spiral guiding blades, a pinion drivably connected to the rotator shaft and a drive guiding device; the drive guiding device comprises a number of racks drivably connected to the pinion, a guide stand disposed at an exterior ring of the fixation drum and fixed to an end of the rack; a limiter chamber is disposed at a side wall of the fixation drum for mounting the guide stand; a permanent magnet is disposed at a bottom end of the guide stand, an electromagnet is disposed inside the limiter chamber for controlling a displacement of the permanent magnet;
the heating control device comprises an infrared electric heater plate disposed an in inside layer of the fixation drum, a number of temperature and humidity sensors disposed at an inner wall of the fixation drum and an operation control computer disposed beside the machine frame; an arced transparent glass is disposed at an upper part of the infrared electric heater plate; the arced transparent glass is aligned with the inner wall of the fixation drum; a number of slide preventing groove is disposed on the arced transparent glass;
the dehumidifying device comprises a flow pipe groove transversely disposed at a side wall of the fixation drum, a water permeable board fitted inside the flow pipe groove and a number of drainage holes disposed at a bottom of the flow pipe groove; slant openings are disposed at an upper part of the flow pipe groove.

2. The electromagnetically controlled blade guided permeation tea fixation control system according to claim 1, characterized in that: the conveying device comprises a first conveyor disposed at a front end of the entrance and a second conveyor disposed at a back end of the exit.

3. The electromagnetically controlled blade guided permeation tea fixation control system according to claim 1, characterized in that: the cooling device comprises a channel box inserted into a back end of the second conveyor, a cooler compressor disposed at an upper part of the channel box, a cold air mouth is disposed inside the channel box.

4. The electromagnetically controlled blade guided permeation tea fixation control system according to claim 1, characterized in that: the infrared electric heater plate, the temperature and humidity sensors, the motor, the conveying device, the electromagnet and the cooler device are electrically connected to the operation control computer.

5. The electromagnetically controlled blade guided permeation tea fixation control system according to claim 1, characterized in that: the water permeable board is made of permeable ceramics.
